(19) United States
(12) Patent Application Publication
(10) Pub. No.: US 2018/0145938 A1
(43) Pub. Date: May 24, 2018

(54) SYSTEMS AND METHODS FOR CONTENT SHARING WITH A PEER

(71) Applicant: Facebook, Inc., Menlo Park, CA (US)

(72) Inventors: Gaurav Lochan, Palo Alto, CA (US); William Shun Xiao, New York, NY (US); Rama Ajit Karve, Redmond, WA (US); Bhavana Vattompadath Radhakrishnan, Union City, CA (US)

(21) Appl. No.: 15/359,540

(22) Filed: Nov. 22, 2016

(51) Int. Cl. H04L 12/58; H04L 29/08

(52) U.S. Cl. CPC H04L 51/10; H04L 51/32; H04L 51/20; H04L 51/38; H04L 67/306

(57) ABSTRACT

Systems, methods, and non-transitory computer readable media are configured to evaluate, by a computing system associated with a user, a sharing policy associated with a media content item. It is determined whether provision of the media content item to a second computing system associated with a second user is permissible under the sharing policy. The media content item is transmitted to the second computing system in a peer to peer manner when the provision is permissible under the sharing policy.

### FIELD OF THE INVENTION

The present technology relates to media content sharing. More particularly, the present technology relates to techniques for sharing media content items between peer computing systems.

### BACKGROUND

Users often utilize computing devices for a wide variety of purposes. Users can use their computing devices to, for example, interact with one another, access media content, share media content, and create media content. In some cases, media content can be provided by users of a social networking system. The media content can include one or a combination of text, images, videos, and audio. The media content may be published to the social networking system for consumption by others.

Under conventional approaches, media content can be maintained by a social networking system. In some instances, computing devices of users of the social networking system can access media content items through a wide area network connection with the social networking system. For example, media content items can be downloaded through the network connection from the social networking system to a computing device of a user. A quality of the network connection and data usage costs associated the network connection are some factors that can limit sizes and amounts of media content items downloaded by the computing device.

### SUMMARY

Various embodiments of the present technology can include systems, methods, and non-transitory computer readable media configured to evaluate, by a computing system associated with a user, a sharing policy associated with a media content item. It is determined whether provision of the media content item to a second computing system associated with a second user is permissible under the sharing policy. The media content item is transmitted to the second computing system in a peer to peer manner when the provision is permissible under the sharing policy.

In some embodiments, the media content item is at least one of a video, a photo, a photo album, a web page, a text story, an audio story, and a reshare.

In some embodiments, the transmitting the media content item to the second computing system is based on a local area communication protocol.

In some embodiments, the local area communication protocol comprises at least one of Bluetooth, Wi-Fi Direct, and a wireless ad hoc network.

In some embodiments, the media content item is downloaded by the computing system from a server associated with a social networking system and the transmitting the media content item to the second computing system does not involve the server.

In some embodiments, a scan is performed to identify computing systems within a local area of the computing system. A determination of local connections of the user is obtained based on the identified computing systems and a list of connections of the user.

In some embodiments, the user is prompted to share the media content item with the second user based on sharing data determined by a machine learning model. The second user is among the local connections. The sharing data relates to at least one of a determination of media content items to be shared, local connections to whom the media content items can be shared, and a time or context for sharing the media content items.

In some embodiments, users in an area local to the computing system are not identified when the users are not connections of the user.

In some embodiments, the transmission of the media content item to the second computing system comprises providing the second media content item for presentation as a story in a newsfeed for the second user; and providing the second media content item to be stored in a folder maintained by the second computing system.

In some embodiments, the sharing policy is determined by a content provider of the media content item.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example peer content module, according to an embodiment of the present technology.

FIG. 2 illustrates an example peer sharing module, according to an embodiment of the present technology.

FIG. 3 illustrates an example interface for sharing media content items, according to an embodiment of the present technology.

FIG. 4A illustrates an example interface for specifying an option to share a media content item, according to an embodiment of the present technology.

FIG. 4B illustrates an example interface for presenting a prompt to share a media content item, according to an embodiment of the present technology.

FIG. 5 illustrates an example method relating to sharing of a media content item, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Peer to Peer Sharing of Media Content

Users often utilize computing devices for a wide variety of purposes. Users can use their computing devices to, for example, interact with one another, access media content, share media content, and create media content. In some cases, media content can be provided by users of a social networking system. The media content can include one or a combination of text, images, videos, and audio. The media content may be published to the social networking system for consumption by others.

Under conventional approaches, media content can be maintained by a social networking system. In some instances, computing devices of users of the social networking system can access media content items through a wide area network connection with the social networking system. For example, media content items can be downloaded through the network connection from the social networking system to a computing device of a user. A quality of the network connection and data usage costs associated the network connection are some factors that can limit sizes and amounts of media content items downloaded by the computing device. For example, in certain regions where wide area network communications have bandwidth constraints or are associated with significant data usage costs, users can be discouraged from downloading media content items.

An improved approach rooted in computer technology overcomes the foregoing and other disadvantages associated with conventional approaches specifically arising in the realm of computer technology. Systems, methods, and computer readable media of the present technology can allow a first computing device (or system) associated with a first user to download media content items from a social networking system. The media content items can include, for example, videos, a photo, photo albums, web pages, stories (e.g., text or non-text, audio, etc.), and reshares of media content items. After downloading a media content item, the first computing device can identify connections (e.g., friends) of the first user in the social networking system that are within a local area of the first computing device. The identification of local connections within the local area of the first computing device can be performed by scanning for other computing systems based on a local area communication protocol. Based at least in part on historical sharing behavior of the first user, a machine learning model can determine sharing data that informs optimal sharing of media content items by the first user. The sharing data can include, for example, certain media content items that are suitable for sharing with local connections. The sharing data also can include, for example, certain local connections who constitute candidates to receive the media content items, as well as time or context data relating to one or more desirable times or contexts when provision of a media content item to a local connections can be initiated. Upon determination of the sharing data, the first computing device can initiate communications with a second computing device associated with a second user constituting a local connection for receiving a media content item. Before provision of the media content item by the first computing device to the second computing device, a sharing policy associated with the media content item is evaluated to determine whether provision of the media content item is consistent with the sharing policy. The sharing policy can provide a permitted scope of distribution or publication of the media content item. If provision of the media content item to the second computing device is permissible under the sharing policy, the first computing device can provide the media content item to the second computing device through a local area communication protocol in a peer to peer manner. The media content item can be reflected in an associated story that appears in a newsfeed of the second user and can be stored in a folder maintained by the second computing device. Upon selection by the second user of the media content item in the story, the media content item can be presented to the second user through the second computing device. In a similar manner, the second user can potentially share the media content item with a third computing device associated with a third user in a peer to peer manner. More details regarding the present technology are described herein.

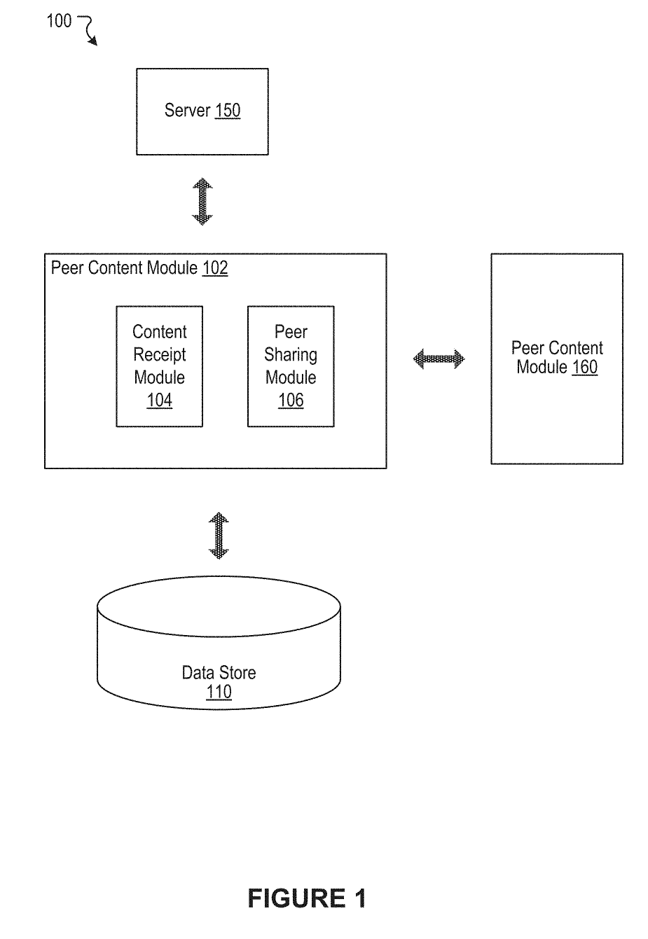

FIG. 1 illustrates an example system 100 including an example peer content module 102 configured to provide media content items from one computing device (or computing system) to another computing device based on a local area (or personal area, etc.) communications protocol in a peer to peer manner, according to an embodiment of the present technology. The media content items can include any types of media content, such as, for example, videos, photo albums, images, audio, text, stories including media content items, reshares of stories, etc. In some embodiments, the peer content module 102 can be implemented on a first computing device, such as a first instance of a user device 610. The peer content module 102 can download media content items from a media content platform associated with at least one server 150. In some embodiments, the server 150 can be part of a social networking system 630. After a media content item is downloaded, the peer content module 102 can provide the media content item from the first computing device to a second computing device, such as a second instance of a user device 610 on which a peer content module 160 is implemented. In some embodiments, the peer content module 160 can be identical or similar in design and operation to the peer content module 102. While provision of a media content item in a peer to peer manner may be discussed herein for purposes of illustration and understanding, the present technology also applies to provision of one or more media content items. The present technology has many applications. For example, in one application where wide area network communications have bandwidth constraints or are associated with significant data usage costs, the provision of media content items between computing devices in a peer to peer manner, rather than from a server to the computing devices, can optimize access to the media content items.

The peer content module 102 can include a content receipt module 104 and a peer sharing module 106. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the peer content module 102 can be implemented in any suitable combinations.

The content receipt module 104 can allow a first user associated with a first computing device on which the peer content module 102 is implemented to download media content items from the server 150. In general, various computing devices, including the first computing device and the second computing device, can be in wide area network communication with the server 150 to access and download media content items from the server 150. The server 150 can be part of a media content platform, such as a social networking system, through which media content items are maintained. The wide area network communication between the computing devices and the server 150 can be based on a wide area network communication protocol, such as a wireless network communication protocol. Through the network connection, the first computing device can download a media content item from the server 150. In some embodiments, downloading of the media content item can include streaming to the first computing device. In some instances where coverage or bandwidth relating to wide area network communications are poor (e.g., coverage or bandwidth do not satisfy selected threshold values) or data usage relating to such network communications entails significant expense (e.g., cost of data usage exceeds a selected threshold value), users may choose to minimize downloading media content items from the server 150 through their computing devices and instead benefit from the present technology.

In addition, the content receipt module 104 can receive media content items from other computing devices based on peer to peer transmissions. The media content items can be transmitted to the content receipt module 104 from another computing device based on a communication connection (or link) relating to a local area communication protocol. In some embodiments, a media content item can be received as a stream from the first computing device to the second computing device. Upon receipt of a media content item, the content receipt module 104 can present the media content item as a story in a newsfeed for the first user. In addition, the content receipt module 104 can hold the media content item in a folder (e.g., saved file folder) maintained by a data store of the first computing device, such as the data store 110. Upon selection by the first user of the story, the associated media content item can be presented (e.g., played) for the first user through an interface (e.g., touch screen) of the first computing device.

The peer sharing module 106 can identify connections (e.g., friends) of the first user in a social networking system that are within a local area of the first computing device. A machine learning model can determine sharing data that informs optimal sharing of media content items by the first computing device with local connections of the first user. Upon determination of the sharing data, the first computing device can set up a communication connection with one or more other computing devices associated with other users constituting local connections for receiving the media content items. Before provision of a media content item by the first computing system to a second computing system associated with a second user that is a local connection of the first user, a sharing policy associated with the media content item can be evaluated to determine whether the provision of the media content item is consistent with the sharing policy. When the sharing policy so permits, the first computing device can provide the media content item to the second computing device through a local area communication protocol in a peer to peer manner for presentation to the second user through the second computing device. Functionality of the peer sharing module 106 is described in more detail herein.

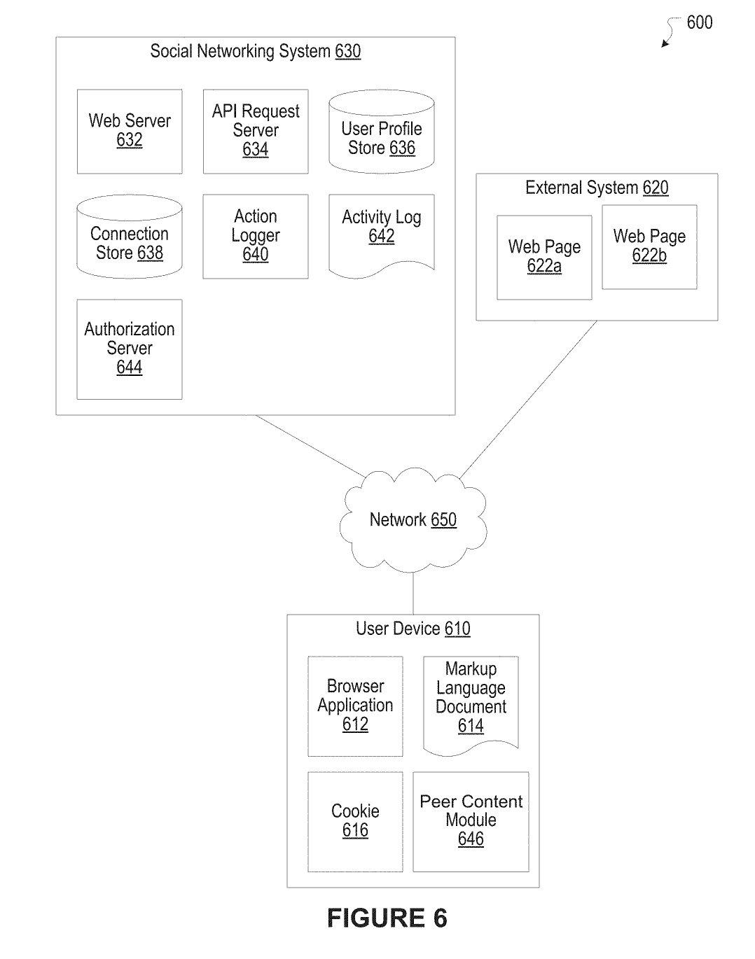

In some embodiments, the peer content module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the peer content module 102 can be, in part or in whole, implemented as software running on one or more computing devices or systems. For example, the peer content module 102 can be implemented as or within a dedicated application (e.g., app), a program, or an applet running on a user computing device or client computing system. In some instances, the peer content module 102 can be, in part or in whole, implemented within or configured to operate in conjunction or be integrated with client computing device, such as a user device 610 of FIG. 6. As another example, the peer content module 102 can be, in part or in whole, implemented within or configured to operate in conjunction or be integrated with a social networking system (or service), such as a social networking system 630 of FIG. 6. It should be understood that many variations are possible.

The system 100 can include a data store 110 configured to store and maintain various types of data, such as data relating to support of and operation of the peer content module 102. The data store 110 also can maintain other information associated with a social networking system. The information associated with the social networking system can include data about users, social connections, social interactions, locations of connections, and media content items. As shown in the example system 100, the peer content module 102 can be configured to communicate and/or operate with the data store 110. In some embodiments, the data store 110 can be implemented on a computing device that implements the peer content module 102.

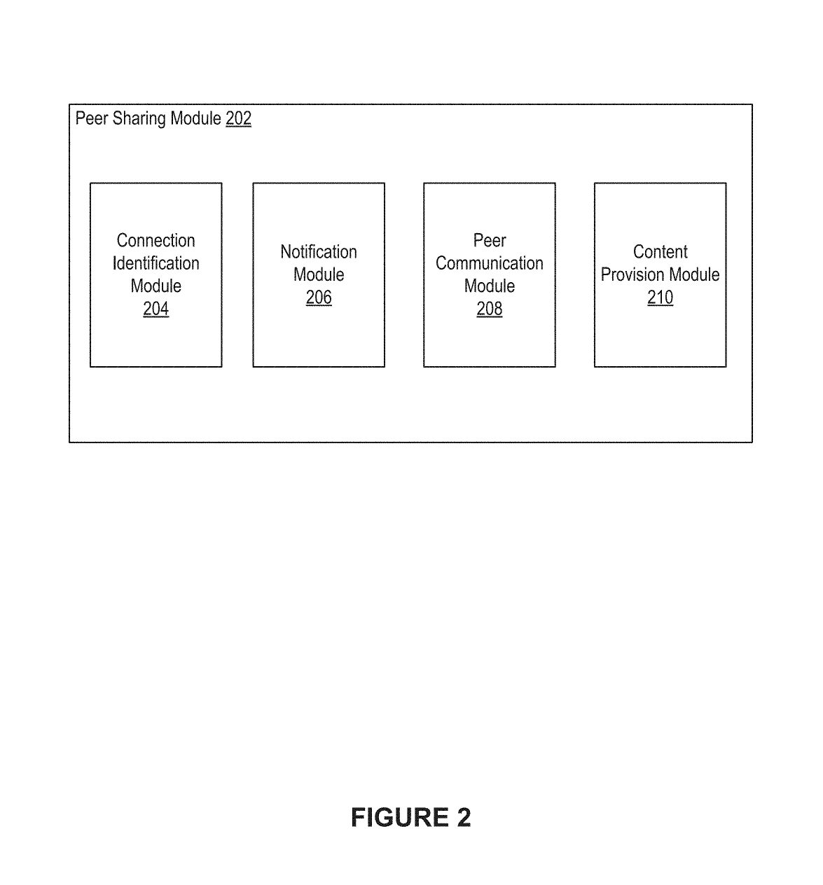

FIG. 2 illustrates an example peer sharing module 202, according to an embodiment of the present technology. In some embodiments, the peer sharing module 106 of FIG. 1 can be implemented with the peer sharing module 202. The peer sharing module 202 can include a connection identification module 204, a notification module 206, a peer communication module 208, and a content provision module 210.

The connection identification module 204 can identify local connections of the first user associated with the first computing device. The local connections can include any type of connections of the first user on a social networking system, such as friends, relatives, close friends, etc. The local connections can be connections of the first user who are within a local area of the first computing device. In some embodiments, the local area can be a distance or geo region in which the first computing device can establish communications, such as local area communications, with another computing device, such as the second computing device, in a peer to peer manner.

The connection identification module 204 can cause the first computing device to perform a scan around a position of the first computing device based on a local area communication protocol to identify other nearby computing devices. The local area communication protocol can include, for example, Bluetooth, Wi-Fi Direct, or a wireless ad hoc network. In some embodiments, the scans can be performed periodically at a selected frequency. Addresses (or identifications) of computing devices that are identified by the scan can be provided by the first computing device to the server 150. Based on a list of connections (e.g., friends, relatives, special friends, etc.) of the first user, the server 150 can identify local connections of the first user that are within a local area of the first computing device. The identified local connections can be provided to the connection identification module 204. Identification of users who may be in an area local to the first user but are not connections of the first user are not provided to the connection identification module 204 or otherwise provided to the first user. In some embodiments, the list of connections of the first user can be maintained by the first computing device for access by the connections identification module 204. In some instances, based on the list of connections of the first user maintained by the first computing device, the first computing device can identify local connections of the first user.

The notification module 206 can determine sharing data that informs optimal sharing of media content items by the first computing device. The sharing data can include, for example, selections of media content items that constitute suitable candidates for sharing with local connections. The sharing data also can include, for example, certain local connections who constitute suitable candidates to receive the selections of media content item. The sharing data also can include, for example, time or context data relating to one or more desirable times or contexts when provision of a particular media content item to a local connection can be initiated. For example, the sharing data can identify a particular media content item for sharing. In this example, the sharing data also can provide information relating to a match between the media content item, or subject matter reflected by the media content item, and interests of a local connection of the first user. The determination of a match can inform to which of one or more local connections the first computing device can provide the media content item. As another example, the sharing data can provide information relating to a time or context when the first user can be optimally prompted to share a media content item with a local connection.

The notification module 206 can use the sharing data to prompt the first user to share a media content item. For a media content item, the notification module 206 can determine one or more local connections with whom the first user would most likely desire sharing the media content item and, in some instances, a time or context for prompting the first user to initiate sharing of the media content item with the local connections. In some embodiments, a prompt or notification to share a media content item with a local connection can be provided to the first user in response to the first user providing an indication to the first computing device that the first user desires to share the media content item. For example, the first user can provide an input or command to an interface of the first computing device to share a media content item after the media content item is downloaded or after the first user has accessed the media content item. In some embodiments, a prompt or notification to share a media content item with a local connection can be provided to the first user automatically and not in response to an input or command of the first user indicating that the first user desires to share the media content item. For example, the notification module 206 automatically can prompt the first user to share a particular media content item with a particular local connection at a particular time or context based on the sharing data.

In some embodiments, the notification module 206 can implement one or more machine learning models to determine sharing data for the first user. Training data to train a machine learning model can include historical sharing behavior of the first user. In some embodiments, the training data also can include historical sharing behavior of other users, including but not limited to users who are demographically similar to the first user, connections of the first user, and other users. The training data can include information relating to media content items that were shared and subject matter (or concepts) reflected by the media content items, as well as information relating to particular users to whom the media content items were shared. Information relating to the media content items can be of any type of information, such as the type of media content item (e.g., video, image, audio, media content item that appears in a newsfeed, etc.). The subject matter reflected by media content items can be any type of subject matter, including, for example, sports, a particular sports team, humor, a music band, political events, adventure, culture, etc. The training data also can include information relating to timing and context associated with initiation of sharing media content items. The information relating to timing for initiating sharing can be any type of timing, including, for example, a particular time or time period (e.g., morning, 4-7 pm, holidays, weekdays, etc.) or a predetermined time after the media content item was downloaded or accessed by the first user. The information relating to context for initiating sharing can be any suitable type of context, including, for example, the first user accessing her newsfeed, the first user messaging the second user, the first user riding public transit, etc. The machine learning model can be continually retrained based on new sharing behavior data.

In some embodiments, the notification module 206 can determine sharing data for the first user based on the machine learning model and a media content item downloaded by the first computing device. The media content item, or metadata associated with the media content item, can be provided to the machine learning model. The machine learning model, in turn, can provide a determination of one or more users to whom the first user is most inclined to share the media content item. The machine learning model also can determine a time or context during which the first user is most inclined to initiate sharing of the media content item. For example, a particular media content item, such as a video reflecting a comedic theme, can be downloaded by the first user and provided to the machine learning model. In this example, the machine learning model can determine that, among the local connections of the first user, the first user will be most likely desire to share the video with the second user. Further to this example, the machine learning model may determine that the first user will most likely desire to share the video after the first user completes her work day. The determined sharing data can be used to provide an appropriate prompt to the first user to share the media content item.

The peer communication module 208 can establish a peer to peer communication connection between the first computing device and the second computing device. The peer communication module 208 can establish the communication link based on a determination that the first computing device is to share a media content item with the second computing device. Establishment of the communication connection can be based on a particular local area communication protocol supporting communication between the first computing device and the second computing device. The establishment of the communication connection can include creation of a physical communication channel between the computing devices and a handshaking technique to setup communication.

The content provision module 210 can evaluate a sharing policy associated with a media content item to be shared. In some embodiments, a sharing policy associated with a media content item can be downloaded by the first computing device when the media content item is downloaded. In some embodiments, the sharing policy can be determined by a content provider of the media content item. The sharing policy can provide rules regarding permissibility of sharing the media content item by the first computing device. For example, the sharing policy can provide that the media content item cannot be shared at all. In that event, the first user can access the media content item but cannot share the media content item with another user. As another example, the sharing policy can provide that the media content item can be shared subject to certain constraints. For instance, the constraints can provide that the media content item can be shared with first degree (or direct) friends of the content provider (or the first user), second degree friends of the content provider, or third degree friends of the content provider, or so on. In another instance, when the sharing policy is not subject to constraints, the media content item can be shared with the public. In some embodiments, the sharing policy can provide and restrict sharing of the media content item by the first user based on any suitable constraint not limited to friendship status or degree of friendship. Such constraints can include, for example, a region, a demographic feature, etc.

When provision of a media content item to the second computing device is permitted by a sharing policy, the content provision module 210 can transmit the media content item and the associated sharing policy to the second computing device. Transmission of the media content item from the first computing device to the second computing device can be performed in a peer to peer manner that does not involve the server 150. In some embodiments, the content provision module 210 can provide the media content item to the second computing device so that the media content item can be presented through an interface of the second computing device. The interface can be, for example, a touch screen of the second computing device. For example, the second computing device can configure the media content item to appear as a story in a newsfeed for the second user. In addition, the second computing device can store the media content item in a folder (e.g., saved filed folder) maintained by a data store of the second computing device. Upon selection by the second user of the story associated the media content item in the newsfeed, the media content item can be presented through the interface of the second computing device. The ability of the first computing device to share the media content item with the second computing device in a peer to peer manner can relieve the second user of bandwidth constraints or significant data usage costs associated with wide area network communications. Based on constraints of the sharing policy, the second computing device, in turn, can further share the media content item with other computing devices in a peer to peer manner. When provision of the media content item to the second computing device is not permitted by the sharing policy, the content provision module 210 does not transmit the media content item to the second computing device.

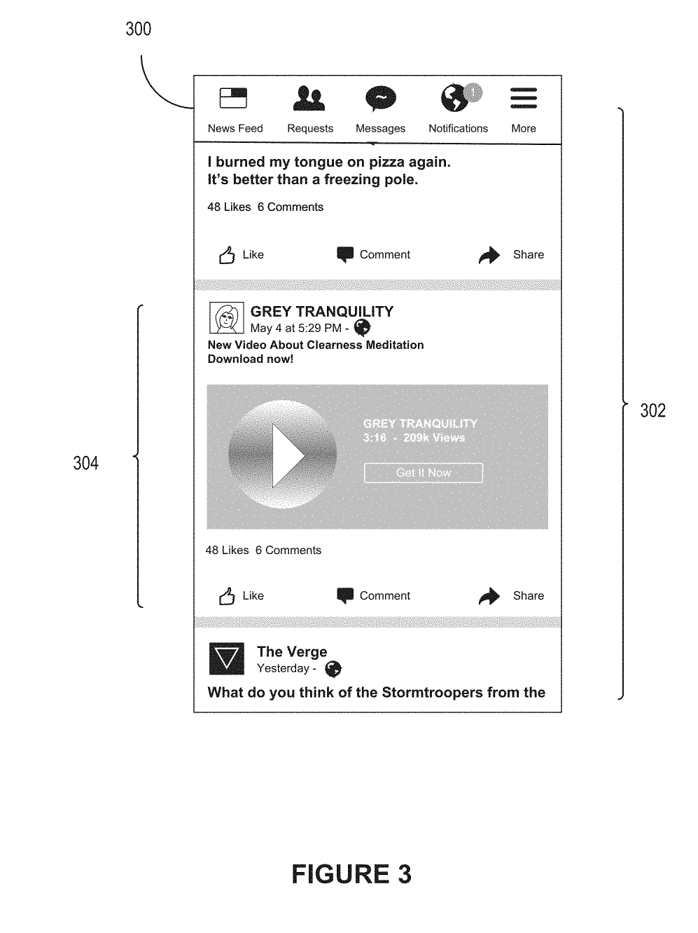

FIG. 3 illustrates a first example interface 300 associated with a first computing device of a first user, according to an embodiment of the present technology. The interface 300 can allow the first user to access media content items. As shown, media content items are presented as stories in a newsfeed 302 for the first user. The newsfeed 302 includes a story 304 including a media content item. In this example, the media content item is a video. In other examples, other types of media content items are possible. In the example shown, the media content item has been downloaded from a server associated with a social networking system to the first computing device. The first computing device and the social networking system established network communication based on a wide area network communication protocol to download the media content item. The media content item can be shared by the first computing device to another computing device in a peer to peer manner without involvement from the server.

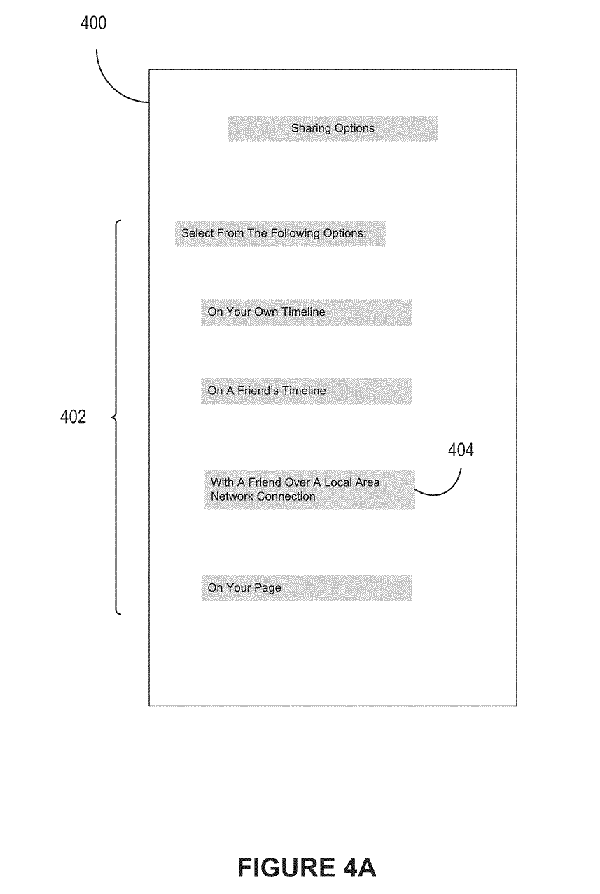

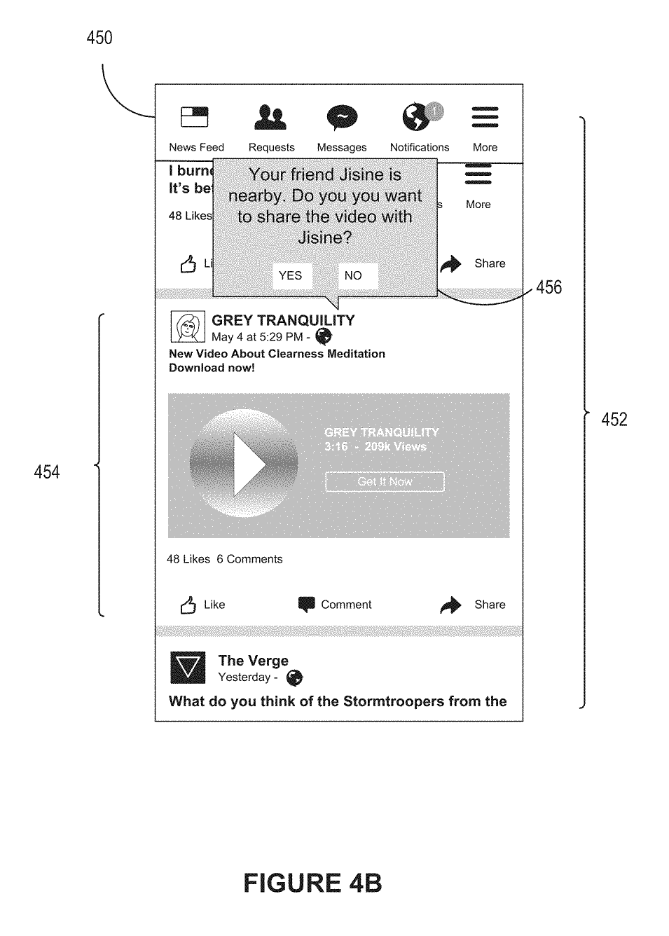

FIG. 4A illustrates an example interface 400 associated with a first computing device of a first user, according to an embodiment of the present technology. The interface 400 can be presented after the first user provides an indication that a media content item downloaded to the first computing device is to be shared. The indication can be provided as an input or command applied to the interface 400. In response to the input or command, sharing options 402 can be presented to the first user through the interface 400. The sharing options 402 provide various surfaces on a social networking system to which the media content item can be shared. The sharing options 402 include an option 404 to share the media content item with a friend or other connection over a local area connection. The option 404 can be presented to the first user after a determination that sharing with the friend is not violative of a sharing policy associated with the media content item. The friend can be a local connection that has been determined to be within an area local to the first computing device, as discussed in connection with the peer sharing module 202. In some embodiments not illustrated, a list of local connections of the first user can be presented through the interface 400 for selection. The first user can select one or more local connections in the list for receiving the media content item.

FIG. 4B illustrates an example interface 450 associated with a first computing device of a first user, according to an embodiment of the present technology. The interface 450 can present a newsfeed 452. The newsfeed 452 can include a story 454 associated with a media content item. In the example shown, the media content item has been downloaded by the first computing device from a server associated with a social networking system. A prompt (or notification) 456 automatically appears through the interface 450. The prompt 456 identifies a second user (i.e., Jisine) associated with a second computing device to which the media content item can be shared. The prompt 456 can be presented based on a determination of sharing data, such as the media content item being suitable for sharing, the second user being a suitable recipient of the media content item, and a time or context that is appropriate to initiate sharing, as discussed in connection with the peer sharing module 202. In addition, the prompt 456 can be presented based on a determination that sharing the media content item with the second user is not violative of a sharing policy associated with the media content item. If the first user chooses to share the media content item with the second computing device, first computing device and the second computing device can establish a communication connection based on a local area communication protocol to allow transmission of the media content item to the second computing device in a peer to peer manner. The media content item can be transmitted from the first computing device to the second computing device without involvement of the server. The media content item can be transmitted to the second computing device so that the media content item appears as a story in a newsfeed for the second user and so that the media content item is stored in a folder maintained by the second computing device. Accordingly, the second user can enjoy access to the media content item without experiencing difficulties associated with bandwidth constraints or data usage charges relating to wide area network communications.

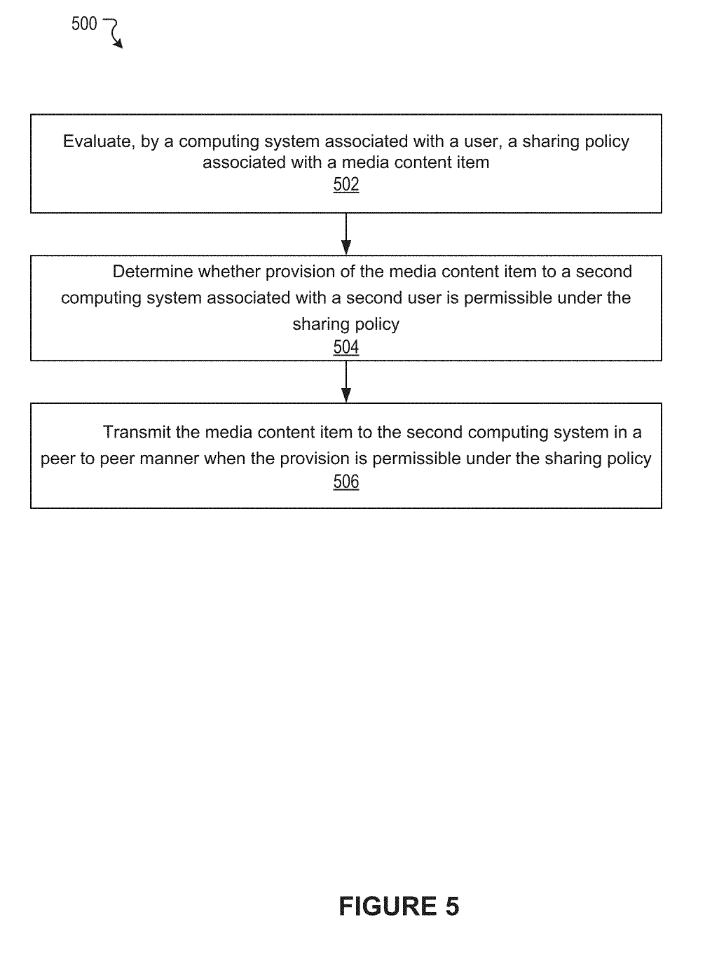

FIG. 5 illustrates an example method 500 relating to management of a broadcast, according to an embodiment of the present technology. It should be appreciated that there can be additional, fewer, or alternative steps performed in similar or alternative orders, or in parallel, in accordance with the various embodiments and features discussed herein unless otherwise stated.

At block 502, the method 500 can evaluate, by a computing system associated with a user, a sharing policy associated with a media content item. At block 504, the method 500 can determine whether provision of the media content item to a second computing system associated with a second user is permissible under the sharing policy. At block 506, the method 500 can transmit the media content item to the second computing system in a peer to peer manner when the provision is permissible under the sharing policy. Other suitable techniques that incorporate various features and embodiments of the present technology are possible.

It is contemplated that there can be many other uses, applications, features, possibilities, and variations associated with various embodiments of the present technology. For example, users can choose whether or not to opt-in to utilize the present technology. The present technology also can ensure that various privacy settings, preferences, and configurations are maintained and can prevent private information from being divulged. In another example, various embodiments of the present technology can learn, improve, and be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, one or more functionalities of a peer content module 646 can be implemented in the user device 610. The peer content module 646 can be implemented with the peer content module 102, as discussed in more detail herein. In some embodiments, the social networking system 630 can include or implement one or more functionalities of the peer content management module 646.

### Hardware Implementation

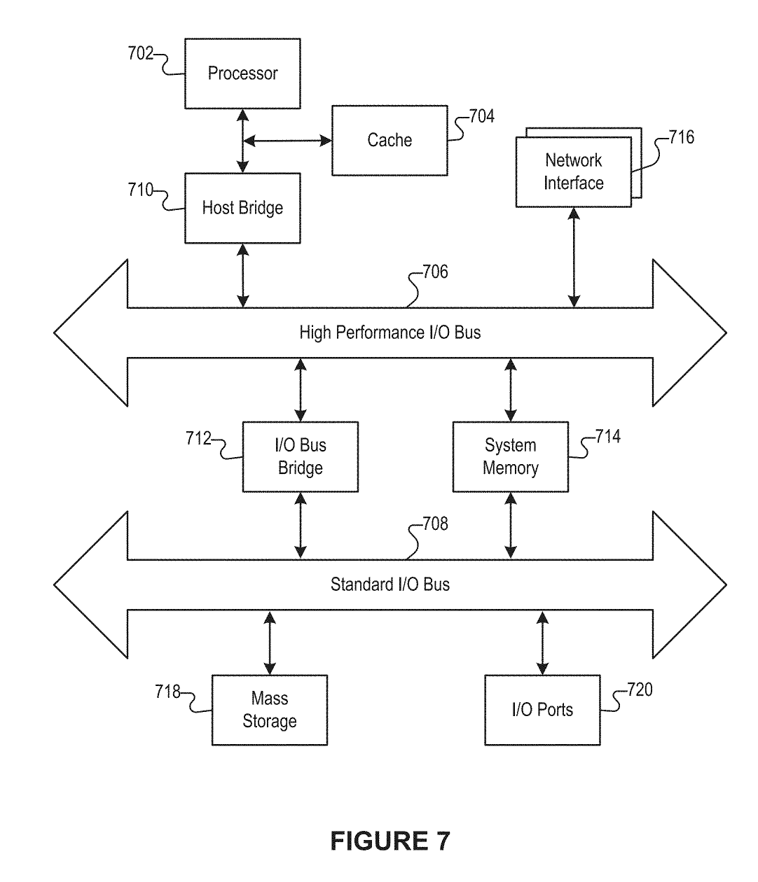

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
evaluating, by a computing system associated with a user, a sharing policy associated with a media content item;
determining, by the computing system, whether provision of the media content item to a second computing system associated with a second user is permissible under the sharing policy; and
transmitting, by the computing system, the media content item to the second computing system in a peer to peer manner when the provision is permissible under the sharing policy.

2. The computer-implemented method of claim 1, wherein the media content item is at least one of a video, a photo, a photo album, a web page, a text story, an audio story, and a reshare.

3. The computer-implemented method of claim 1, wherein the transmitting the media content item to the second computing system is based on a local area communication protocol.

4. The computer-implemented method of claim 3, wherein the local area communication protocol comprises at least one of Bluetooth, Wi-Fi Direct, and a wireless ad hoc network.

5. The computer-implemented method of claim 1, wherein the media content item is downloaded by the computing system from a server associated with a social networking system and the transmitting the media content item to the second computing system does not involve the server.

6. The computer-implemented method of claim 1, further comprising:
performing a scan to identify computing systems within a local area of the computing system; and
obtaining a determination of local connections of the user based on the identified computing systems and a list of connections of the user.

7. The computer-implemented method of claim 7, further comprising:
prompting the user to share the media content item with the second user based on sharing data determined by a machine learning model, wherein
the second user is among the local connections, and
the sharing data relates to at least one of a determination of media content items to be shared, local connections to whom the media content items can be shared, and a time or context for sharing the media content items.

8. The computer-implemented method of claim 1, further comprising:
not identifying users in an area local to the computing system when the users are not connections of the user.

9. The computer-implemented method of claim 1, wherein the transmitting the media content item to the second computing system comprises:
providing the second media content item for presentation as a story in a newsfeed for the second user; and
providing the second media content item to be stored in a folder maintained by the second computing system.

10. The computer-implemented method of claim 1, wherein the sharing policy is determined by a content provider of the media content item.

11. A computing system comprising:
at least one processor; and
a memory storing instructions that, when executed by the at least one processor, cause the computing system to perform:
evaluating, by the computing system associated with a user, a sharing policy associated with a media content item;
determining whether provision of the media content item to a second computing system associated with a second user is permissible under the sharing policy; and
transmitting the media content item to the second computing system in a peer to peer manner when the provision is permissible under the sharing policy.

12. The system of claim 11, wherein the media content item is at least one of a video, a photo album, a text story, and a reshare.

13. The system of claim 11, wherein the transmitting the media content item to the second computing system is based on a local area communication protocol.

14. The system of claim 13, wherein the local area communication protocol comprises at least one of Bluetooth, Wi-Fi Direct, and a wireless ad hoc network.

15. The system of claim 11, wherein the media content item is downloaded by the computing system from a server associated with a social networking system and the transmitting the media content item to the second computing system does not involve the server.

16. A non-transitory computer-readable storage medium including instructions that, when executed by at least one processor of a computing system, cause the computing system to perform a method comprising:
evaluating, by the computing system associated with a user, a sharing policy associated with a media content item;
determining whether provision of the media content item to a second computing system associated with a second user is permissible under the sharing policy; and
transmitting the media content item to the second computing system in a peer to peer manner when the provision is permissible under the sharing policy.

17. The non-transitory computer-readable storage medium of claim 16, wherein the media content item is at least one of a video, a photo album, a text story, and a reshare.

18. The non-transitory computer-readable storage medium of claim 16, wherein the transmitting the media content item to the second computing system is based on a local area communication protocol.

19. The non-transitory computer-readable storage medium of claim 18, wherein the local area communication protocol comprises at least one of Bluetooth, Wi-Fi Direct, and a wireless ad hoc network.

20. The non-transitory computer-readable storage medium of claim 16, wherein the media content item is downloaded by the computing system from a server associated with a social networking system and the transmitting the media content item to the second computing system does not involve the server.
